(19) United States
(12) Patent Application Publication
(10) Pub. No.: US 2024/0200435 A1
(43) Pub. Date: Jun. 20, 2024

(54) Sand Hand

(71) Applicant: Shawnacy Leonard Larson, Andrews, TX (US)

(72) Inventor: Shawnacy Leonard Larson, Andrews, TX (US)

(21) Appl. No.: 18/069,212

(22) Filed: Dec. 20, 2022

(51) Int. Cl. E21B 43/34

(52) U.S. Cl. CPC E21B 43/35; E21B 43/2607

(57) ABSTRACT

The Sand Hand is a piece of mobile equipment that mounts on an open top tank and filters out and weighs frac sand in an oil field well test. It is faster, easier and more cost efficient to rig up, rig down and mobilize. It makes the process of weighing frac sand faster, it weighs frac sand more accurately, it makes it safer to access and operate, more user friendly to operate and much cheaper to build.

### BACKGROUND OF THE INVENTION

When an oil well is fraced, the formation retaining the oil is fractured with hydraulic pressure that is being forced into the well with big water pumps. Sand is then forced into the fractures, this bridges the fractures keeping the fractures from closing. This allows the oil to flow through the sand to the pierced pipe which will take it to the surface. When the well is opened after a frack the loose sand will flow with the water that was used to pressure up the formation along with some natural gas and oil. If the well was to be opened wide open the loose sand would cut the packed sand bridging the fractures, the fractures would then collapse and the benefits of fracking the well would be lost. When the well is first opened it is partially opened and the sand is filtered from the flow of the well. Every hour after the well is opened the filtered sand from the prior hour is weighed. When the amount of sand being returned to the surface resides to ounces, which may have been gallons when the well was first opened, the well will be opened a little more. This will cause a surge in the well and the well will start bringing up loose sand again until it resides. This process will be repeated until the loose sand has slowly been extracted and the well is wide open.

### Existing Equipment

The existing equipment uses a filter sock at the bottom of a hopper that retains the sand as the water and oil flow through the filter sock into an open top tank. The sand is weighed, reported and then dumped into the open top tank.

The Problems with the Existing Equipment are:
1. The equipment is not fast, easy or cost efficient to rig up, rig down or mobilize because, it is big and heavy, requiring heavy equipment to rig it up, rig it down and truck to transport it.
2. The equipment takes a long time to extract the water because, it does not have a way to quickly extract the remaining liquids that sit on top of the sand inside the filter sock,
3. The equipment does not weigh an accurate weight because, there is no way to remove residual sand from the hopper.
4. The steps of the equipment is not adaptable to any size half tank because, it doesn't have individual steps with handrails that latch together making a custom fit to any height tank.
5. The equipment is not safe to access and operate because, it does not have a working deck and steps with handrails.
6. The equipment is not operator friendly because, it does not have a working deck that puts the operator within an arm's length of all controls.
7. The existing equipment is big and expensive to build.

### BRIEF SUMMARY OF THE INVENTION

This is how the invention solves the existing problems. Claims.
1. The Sand Hand is faster, easier and cost efficient to rig up, rig down and mobilize because, it is made up of small attachable components, so it can be assembled on the ½ tank in the field by hand quickly and not needing heavy equipment.
2. The sand hand makes the process faster because, the sock can be rotated to a 90* angle quickly extracting excess water that sits on top.
3. The sand hand weighs a more accurate weight because, the residual sand can be shaken out of the filter sock by jerking the carriage cable.
4. The sand hand is more adaptable because, the steps individually attach making it a custom fit to any height tank.
5. The sand hand is safer to access and operate because, it has a working deck and steps with handrails.
6. The sand hand is more operator friendly because, the working deck puts the operator within an arm's length of all controls
7. The sand hand is more cost efficient because, it is much smaller, requiring less materials and labor to build.

### DETAILED DESCRIPTION OF THE INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein, rather, these embodiments are provided so that this disclosure will be through and complete, and will fully convey its scope to those skilled in the art. Like numbers referred to like elements throughout. In an embodiment, usage of the term “about” includes +/−5% of the sighted magnitude. In an embodiment, usage of the term “substantially” includes +/−5% of the sighted magnitude.

It is to be further understood that the scope of the present disclosure is not limited to the exact details of construction, operation, exact materials, or embodiments shown and described, as modifications and equivalence will be apparent to one skilled in the art. In the drawings and specifications, there have been disclosed illustrative embodiments and although specific terms are employed, they are used in a generic and descriptive sense only and not for the purpose of limitation.

### Specifications

### How the Sand Hand Works

The sand hand is quickly easily rigged up by hand on site. The Sand hand body is placed on the peg which is mounted on the working deck. The working deck hangs on the side of a half tank. The deck is leveled by adjustable horizontal support members. The steps are individually mounted to meet any height tank. The deck and each step has it's own handrails. The first step is mounted to the working deck, each step after that is mounted to the prior step. The bottom step is leveled off of unleveled ground with adjustable step jack. An SKO vessel (not part of the invention) separates and retains the sand from a continuous flowing line from the oil well. The sand hand connects to a dump line coming from the SKO vessel. Once an hour, a valve is opened on the SKO vessel to empty the accumulated sand, sending a slurry mixture of sand, oil, water and gas to the sand hand. The slurry enters the sand hand body to one side, creating a cyclonic flow. As the slurry enters it hits a wear plate then flows along the inside wall of the sand hand body causing it to spiral downward leaving a void in the center of the sand hand body. This allows the gas to be separated from the slurry. The gas scoop pulls the gas from the center of the void and routes it to the gas discharge pipe. There are three baffles mounted to the wall of the sand hand body that convert the cyclonic flow to a straight down gravity flow reducing the speed and force of the slurry before it hits the filter sock. The filter sock is where the water and oil will filter out of the sand a fall into the half tank, leaving the sand in the filter sock to be weighed. The detachable carriage is mounted to the sand hand body. The filter sock is mounted to the carriage by an upper and lower sock holder that enables the filter sock to slide upward 2″ on the carriage without restriction. The boomer is mounted to the boom and connected to the scale and the scale is mounted to the scale arm. When the boomer closes the scale arm hooks lift against the upper sock holder and raises the filter sock 2″, converting the weight from the carriage to the scale so the scale can weigh the sand filled sock. This also keeps the mouth of the sock up around the slurry discharge tube when the slurry enters the filter sock. A lower sock holder is attached to the bottom of the filter sock. A cable is attached to the lower sock holder and up to a pully mounted on the boom. The cable has a handle on it. With the scale on, zeroed and the boomer brought into the closed position, the weight will appear on the scale. Once the sand is weighed the boomer is opened lowering the scale arms, the filter sock slides down 2″ freeing it from the slurry discharge pipe and the scale arms. The weight is now transferred from the scale to the carriage. The carriage cable is then pulled rotating the filter sock until the filter sock is upside down and the carriage locks onto the carriage latch. The carriage latch will keep the carriage locked in the upside-down position while the carriage cable is jerked allowing the sand to break loose and fall out of the filter sock through the sand buster that slows the velocity and bust up the clump of sand before it hits the water, eliminating the hazardous chemical liquid from splashing on the operator. Then release the carriage latch and return the filter sock to the raised position, close the boomer lifting the filter sock back into position. It is now ready for another batch of slurry.

### BRIEF DESCRIPTION OF THE SEVERAL VIEWS OF THE DRAWINGS

FIG. 1

A drawing of the sand hand body mounted to the working deck.

FIG. 2

A drawing of the crosscut section of the sand hand with detachable carriage.

FIG. 3

A drawing of the working deck and steps.

FIG. 4

A drawing of the sand hand extension and the sand buster mounted to the carriage.

FIG. 5

A drawing of the filter sock and carriage cable system mounted to the sand hand.

FIG. 6

A drawing showing the forward swing using the carriage cable system that is mounted to the sand hand body.

FIG. 7

A drawing showing the reverse swing using the carriage cable system that is mounted to the sand hand body.

FIG. 8

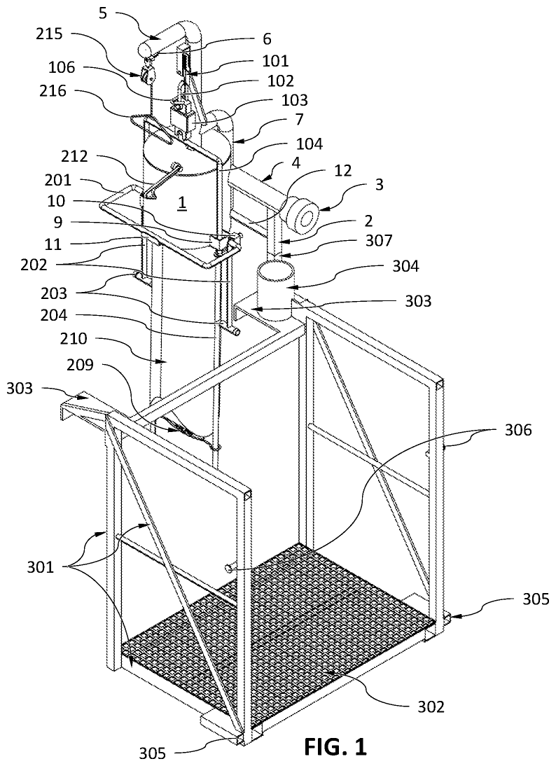

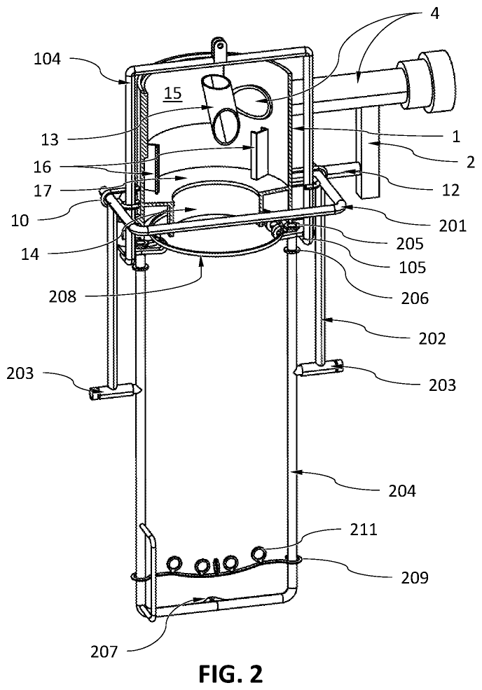

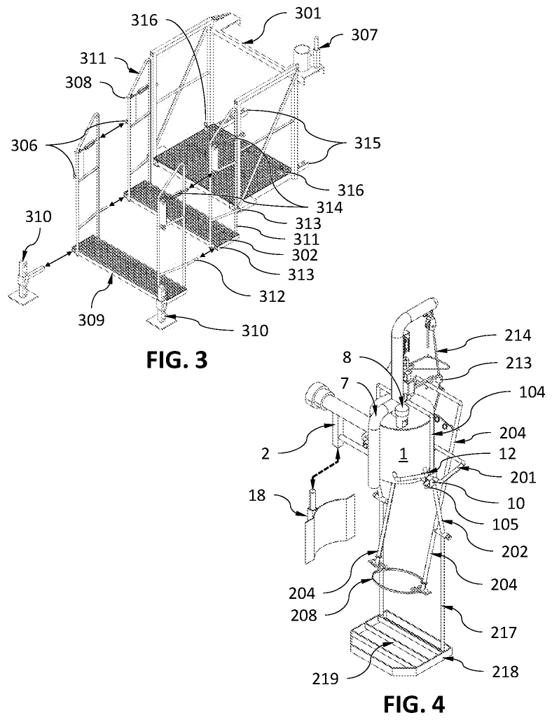

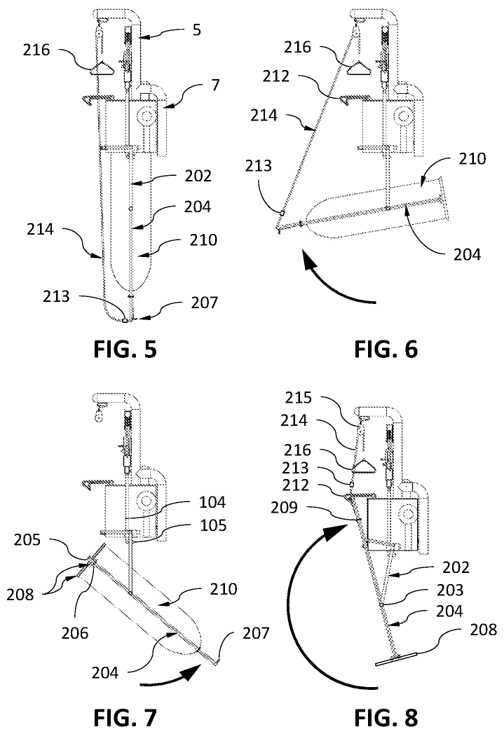

A drawing showing the carriage rotating in a forward swing and locking into the carriage latch.

| Main Body | Scale | Carriage | Deck |
|---|---|---|---|
| 1 Sendhand Body | 101 Boomer | 201 Carriage Handle | 301 Working Deck |
| 2 Peg Mount | 102 Scale Clevis | 202 Carriage Arms | 302 Decking |
| 3 2″ 1502 Thread Half | 103 Scale | 203 Carriage Pivots | 303 Tank Mounts |
| 4 Inlet Pipe | 104 Scale Arms | 204 Carriage | 304 Tool Storage Compartment |
| 5 Boom | 105 Scale Arm Hooks | 205 Sock Upper Restraint | 305 Step Anchor Mount |
| 6 Boom Pulley Mount | 106 Scale Clevis Guide | 206 Sock Lower Restraint | 306 Turnbuckle Anchoring Pins |
| 7 Gas Discharge Pipe | | 207 Carriage Cable Eye | 307 Peg |
| 8 Pressure Relief/Pop Off | | 208 Upper Sock Holder | 308 Step Alignment Pins |
| 9 Scale Arm Guides | | 209 Lower Sock Holder | 309 Step |
| 10 Carriage Mounts | | 210 Filter Sock | 310 Step jack |
| 11 Carriage Support | | 211 Sock Attachment Loops | 311 Hand rails |
| 12 Sendhand Handles | | 212 Carriage Latch | 312 Step Lower Anchor Rod |
| 13 Gas Scoop | | 213 Sock Stop | 313 Anchor Rod Receiver |
| 14 Slurry Discharge Pipe | | 214 Carriage Cable | 314 Turnbuckles |
| 15 Wear Plate | | 215 Carriage Cable Pulley | 315 Adjustable Horizontal Support Member |
| 16 Baffles | | 216 Carriage Cable Handle | 316 Horizontal Support Anchor Pin |
| 17 Floor | | 217 Sand Buster Arms | |
| 18 Peg Extension | | 218 Sand Buster | |
| | | 219 Sand Buster Slats | |

### How the Sand Hand Parts Work in Conjunction with Each Other

The sand hand is picked up by the handles 12 and the peg mount 2 is placed on the peg 307 which is mounted on the working deck 301. If heavy sand accumulation is expected use the peg extension 18 this lifts the sand hand an additional 7″ off the floor of the ½ tank. The working deck 301 hangs on the side of a half tank by the tank mounts 303. The deck is leveled by the adjustable horizontal support members 315. Once the deck is level the horizontal support anchor pin 316 will lock it into position. The working deck 301 has a tool storage compartment 304 to keep an extra scale 103, scale charger and carriage cable 214. The steps 309 are individually mounted to meet any height tank. The working deck 301 and the steps 309 have their own hand rails. The first step 309 is mounted to the working deck 301 each step 309 after that is mounted to the prior step 309 with a turn buckle 314 on each side of the hand rails 311 hooked onto the turn buckle anchor pins 306 and on each side of the step 309 there are 2 step lower anchor rods 312 that slid into the 2 anchor rod receivers 313. The bottom step 309 is leveled off of unleveled ground with adjustable step jack 310. A vessel (not part of the invention) separates and retains the sand from a continuous flowing line from the oil well. The sand hand has a 2″ 1502 thread half 3 on the inlet pipe 4 that connects up to a dump line coming from the vessel. Once an hour a valve is opened on the vessel to empty the accumulated sand, sending a slurry mixture of sand, oil, water and gas to the sand hand. The slurry enters into the sand hand body 1 to one side creating a cyclonic flow. As the slurry enters it hits a wear plate 15 then flows along the inside wall of the sand hand body 1. spiraling downward leaving a void in the center of the sand hand body 1. This allows the gas to be separated from the slurry. The gas scoop 13 pulls the gas from the center of the void and routes it to the gas discharge pipe 7. There are three baffles 16 mounted to the wall of the Sand Hand body 1 that convert the cyclonic flow to a straight down gravity flow reducing the speed and force of the slurry before it hits the floor 17 and out the slurry discharge pipe 14 into the filter sock 210. The filter sock 210 is where the water and oil will filter out of the sand a fall into the half tank leaving the sand in the filter sock 210 to be weighed. The filter sock 210 is mounted on a detachable carriage 204 which is mounted to the sand hand body 1 when the carriage arms 202 rest in the carriage mounts 10 and the carriage handle 201 rest in the carriage support 11. The filter sock 210 is mounted to the carriage 204 by an upper 208 and lower 209 sock holder that enables the filter sock 210 to slide upward 2″ on the carriage 204 without restriction. When the filter sock 210 is in the upright position the upper sock holder 208 rest on the sock lower restraint 206 and is positioned over the scale arm hooks 105. When the scale arms 104 are lifted with the boomer 101 the scale arm hooks 105 lift against the upper sock holder 208 and raises the filter sock 210 2″ converting the weight from the carriage 204 to the scale 103 so the scale 103 can weigh the sand filled sock. This also keeps the mouth of the sock up around the slurry discharge tube 14 when the slurry enters the filter sock 210. The lower sock holder 209 attaches to the bottom of the filter sock 210 by threading the 4 sock attachment loops 211 that are stitched to the bottom of the filter sock 210 through the metal loops 211 on the lower sock holder 209. The carriage cable 214 is attached to the center loop on the lower sock holder 209, then threads through the carriage cable eye 207 on the carriage 204. There is a sock stop 213 crimped on the carriage cable 214 2 inches from the outside of the carriage cable eye 207, this keeps the bottom of the filter sock 210 from falling down or side to side when the filter sock 210 is dumped. From there the carriage cable 214 goes up to the carriage cable pulley 215 which is mounted to the boom pulley mount 6 on the boom 5. The carriage cable handle 216 mounts to the end of the carriage cable 214. The scale arms 104 are mounted to the bottom of the scale 103. The scale clevis 102 mounts to the bottom of the boomer 101 and to the top of the scale 103. The scale clevis 102 rides against the scale clevis guide 106 when the boomer 101 is opened or closed to keep the scale 103 centered over the filter sock 210. With the scale 103 on and zeroed, the boomer 101 can be brought into the closed position and the weight will appear on the scale 103. Once the sand is weighed the boomer 101 is opened lowering the scale arms 104, the filter sock 210 slides down 2″ freeing it from the slurry discharge pipe 14 and the scale arms 104. The carriage cable 214 is then pulled rotating the filter sock 210 and carriage 204 on the carriage pivots 203 until the filter sock 210 is upside down and the carriage 204 locks onto the carriage latch 212. The carriage latches 212 will keep the carriage 204 locked in the upside-down position while the carriage cable 214 is jerked allowing the sand to break loose and fall out of the filter sock 210 onto the sand buster 218, which is mounted to the sand buster arms 217 which are mounted to the carriage arms 202. The sand buster 218 breaks up the sand clump and slows the velocity of the sand as it goes through the sand buster slats 219, eliminating the hazardous chemical liquid from splashing on the operator. The upper sock holder 208 will rest on the sock upper restraint 205 keeping it from falling off the carriage 204. Then release the carriage latch 212 and return the filter sock 210 to the raised position, close the boomer 101 lifting the filter sock 210 back into position. It is now ready for another batch of slurry.

1. The body of the sand hand is a cyclonic gas buster that reduces the high-pressure slurry to atmospheric pressure while separating the gas from the slurry and reroutes it to a gas discharge tube.

2. The sock rotates on the carriage 180 degrees and locks into place, the bottom sock holder slides up and down as the cable is jerked dumping the captured sand and shakes any residual sand from the sock.

3. When the scale is lifted to weigh the sand, the scale lifts the filter sock, freeing it from the sand collection equipment, making the empty weight under 6 lbs, allowing the scale to give a more accurate weight.

4. The sand hand has a working deck with individually mounted steps and handrails making it a custom fit to any height tank, also making it easier and safer to access and operate.
